(19) United States
(12) Patent Application Publication
(10) Pub. No.: US 2012/0020191 A1
(43) Pub. Date: Jan. 26, 2012

(54) Wireless Clock System

(76) Inventor: Ilan Shemesh, Huntingdon Valley, PA (US)

(21) Appl. No.: 13/163,327

(22) Filed: Jun. 17, 2011

Related U.S. Application Data
(60) Provisional application No. 61/355,992, filed on Jun. 17, 2010.

(51) Int. Cl. G04C 11/02

(52) U.S. Cl. 368/47

(57) ABSTRACT

A wireless system and method comprises a plurality of master time sources, each master time source wireless transmitting time signals containing time data, a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks which receives and retransmits the time signals in repeater fashion; and wherein each of the slave clocks is associated and paired with the master time source from which the time signal is first transmitted.

### CROSS REFERENCE TO RELATED APPLICATIONS

This application is a non-provisional application claiming priority on provisional application Ser. No. 61/355,992, filed Jun. 17, 2010, which is incorporated by reference herein.

### BACKGROUND OF THE INVENTION

Traditional wireless clock systems known in the market today typically consist of a “master” clock having a wireless transmitter and multiple secondary or “slave” clocks having wireless receivers. The secondary clocks may be installed in many rooms in a school, industrial location, large office building, or the like. One reason for using a “master-slave” type system is to permit the master clock to maintain the time at all of the secondary clocks in synchronization with the time at the master clock. To do this, typically, the master clock transmits a periodic time signal, correction signal or the like to the secondary clocks. The secondary clocks receive the signal and display the time, or perform a time correction operation, if necessary.

A disadvantage of such a system is that the size of the system is limited to the distance between the master clock transmitter and the secondary clock receivers. Over a long distance, or in electrically noisy or interfering environments, the secondary clocks may not be able to receive valid time signal data from the master clock.

Another disadvantage of this type of system is that the master clock transmitter normally transmits the time signal over a single radio frequency. Therefore, if there is noise or interference at or near that frequency, it will most likely affect the ability of the secondary clocks to receive accurate time data, unless the transmission frequency is changed manually.

Also, in a system containing multiple secondary or slave clocks, each of which may wirelessly transmit simultaneously, another issue to be addressed is how to prevent the slaves from conflicting with each other. In this context, “conflict” means that a clock receives signals from two or more other clocks simultaneously. The signals may be out of phase. If so, the clock receiving both signals would not “know” which signal to use for accurate timekeeping.

An example of a wireless master slave clock system is disclosed in U.S. Pat. No. 7,522,688, incorporated by reference herein. In that patent, slave or secondary clocks or other devices are configured to communicate not only with a master time source such as a master clock, but also with other slave clocks, in cascading fashion. More particularly, each slave clock is configured to both wirelessly receive and wirelessly transmit time signals containing or representing time data. Each slave clock may be configured to operate either as a traditional slave clock, or as a “repeater” device for communicating with other slave clocks or other repeater devices. Normally, only one master clock is included in the system.

As used herein, the term “slave clock” is used to refer to any instrument that operates as a “repeater” or relay device to receive time signals from another source of time data, and then to transmit its own time signals containing the time data to other instruments. The instrument may, but need not, be a “clock” in the traditional sense, namely a device having analog hands or a digital or other display device that physically displays the time.

As used herein, the term “display clock” refers to a clock in the traditional sense, namely a device having analog hands or a digital or other display device that physically displays the time.

If multiple slave clocks are used in a clock installation, a type of “cascade” or “bucket brigade” arrangement is formed. Each slave clock operates in synchronization with both the master clock and with each of the other slave clocks. Since multiple slaves can now “control” or signal other multiple slaves, clock installations of almost unlimited size may be constructed.

This arrangement minimizes or completely prevents signal conflicts at the slave clocks by using frequency hopping and pseudo-randomized selection and timing of frequencies over which time signals are transmitted and re-transmitted. The use of “double randomness” in the transmissions makes it extremely unlikely that a signal conflict will occur at any slave clock.

In that system, the wireless clock system comprises a master time source including means for wirelessly transmitting first time signals containing time data, a first slave clock including means for wirelessly receiving the first time signals, the first time signals causing the first slave clock to operate in synchronization with the master time source, and further including means for wirelessly transmitting second time signals containing the time data, and a second slave clock including means for wirelessly receiving the second time signals, the second time signals causing the second slave clock to operate in synchronization with the first slave clock.

That arrangement also provides a method of operating a wireless clock system, comprising the steps of wirelessly transmitting first time signals from a master time source, the first time signals containing time data, wirelessly receiving the first time signals at a first slave clock, the first time signals causing the first slave clock to operate in synchronization with the master clock, wirelessly transmitting second time signals from the first slave clock, the second time signals containing the time data, and wirelessly receiving the second time signals at a second slave clock, the time signals causing the second slave clock to operate in synchronization with the first slave clock.

That arrangement also provides a wireless clock system comprising a master time source including means for wirelessly transmitting time signals including current time data, at least one slave clock, the slave clock including receiving means for receiving the time signals, and means within the slave clock for conserving power by automatically activating and deactivating the receiving means at predetermined times and at predetermined intervals, each interval being longer than the previous interval, until valid time data is recognized from the time signals.

That arrangement also comprises a method of operating a wireless clock system, comprising the steps of wirelessly transmitting time signals including current time data from a master time source, and activating and deactivating a wireless receiver within a slave clock at predetermined times and at predetermined intervals, each interval being longer than the previous interval, until valid time data is recognized from the time signals.

That arrangement also provides a wireless clock system comprising a master time source having a master time base and having transmitting means for wirelessly transmitting time signals including current time data, at least one slave device a slave time base and having receiving means for receiving the time signals, and means for calibrating the slave time base with the master time base.

That arrangement also provides a wireless clock system comprising a master time source including means for wirelessly transmitting first time signals containing time data, a first repeater including means for wirelessly receiving the first time signals and further including means for wirelessly transmitting second time signals containing the time data.

That arrangement also provides a wireless clock system comprising a clock including means for wirelessly transmitting time signals in a frequency hopping manner being performed in a doubly pseudo-random manner, in which the time signals are transmitted pseudo-randomly from among preselected transmission frequencies within a preselected range and at pseudo-randomly selected transmission start times within a preselected range.

The arrangement also provides a wireless clock system comprising a master time source including means for wirelessly transmitting, at pseudo-random frequencies and at pseudo-random times, time signals containing data representing a current master time and a master time base, at least one slave clock capable of wirelessly and automatically receiving the time signals further including means for wirelessly receiving the time signals, the time signals causing the second slave clock to operate in synchronization with the current master time, and causing a time base of the slave clock to be calibrated with the master time base.

The present invention relates to wireless clock systems.

Wireless clock systems transmit signals wirelessly between the clocks, to synchronize the clocks and to exchange information. Some systems have master/slave clock arrangements. One example is U.S. Pat. No. 7,522,688, assigned to the present assignee herein, The Sapling Company, and is incorporated by reference herein.

### SUMMARY OF THE INVENTION

The present invention provides improvements in such a system.

The present invention provides a wireless system comprising: a plurality of master time sources, each master time source wireless transmitting time signals containing time data; a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks which receives and retransmits the time signals in repeater fashion; and wherein each of the slave clocks is associated and paired with the master time source from which the time signal is first transmitted.

The present invention provides a wireless clock system, comprising: a master time source for wirelessly transmitting time signals containing time data; a plurality of slave clocks for wirelessly receiving time signals which cause the slave clocks to operate in synchronization with a source of the received time signals, wherein the master time source has an internet connection for connection to a master computer for data exchange of operational performance data of the slave clocks.

The present invention provides a wireless clock system comprising: master time source for wirelessly transmitting time signals containing time data; a plurality of slave clocks, each of the slave clocks receiving time signals which cause the slave clocks to operate in synchronization with a source of the received time signals, wherein at least one of the slave clocks operates using a battery power source, and wherein a signal representing the battery level value is transmitted from the slave clock to the master time source for monitoring.

The present invention provides a wireless clock system, comprising: a master time source for wirelessly transmitting time signals containing time data at intervals; a plurality of slave clocks, each of the slave clocks receiving time signals which cause the slave clocks to operate in synchronization with a source of the received time signals, each of said slave clocks transmitting back to said master time source data indicating the number of intervals in which the slave clock has received a time signal.

The present invention provides a wireless clock system, comprising: at least one master time source for wirelessly transmitting time signals containing time data; a plurality of slave clocks for wirelessly receiving time signals which cause the slave clocks to operate in synchronization with a source of the received time signals; wherein the master time source transmits the time signals periodically to effect time synchronization, and wherein each slave clock detects the number of time periods it receives the current time signals and for transmitting back to the number of times it receives the current time signals; and wherein the master time source compares information representing when each slave clock receives the time signals during normal operation with when the slave clocks actually receive the current time signals to determine whether the slave clock is operating normally.

The present invention provides a wireless clock system, comprising: at least one master time source for wirelessly transmitting time signals containing time data; a plurality of slave clocks for wirelessly receiving time signals which cause the slave clocks to operate in synchronization with a source of the received time signals; wherein performance data of each slave clock is transmitted back to the master time source for display and monitoring.

The present invention provides a wireless system comprising: a plurality of master time sources, each master time source wireless transmitting time signals containing time data; a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks; and wherein each of the slave clocks determines the number of repeater slave clocks the time signal passes before being received by the slave clock as a tier value.

The present invention provides a method of operating a wireless system comprising: providing a plurality of master time sources, each master time source wireless transmitting time signals containing time data; providing a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks which receives and retransmits the time signals in repeater fashion; and associating and pairing each slave clock with the master time source from which the time signal is first transmitted.

The present invention provides a method of operating a wireless clock system, comprising:

providing a master time source for wirelessly transmitting time signals containing time data;

providing a plurality of slave clocks for wirelessly receiving time signals which cause the slave clocks to operate in synchronization with a source of the received time signals; and connecting the master time source to a master computer for data exchange of operational performance data of the slave clocks.

The present invention provides a method of operating a wireless clock system comprising:

providing a master time source for wirelessly transmitting time signals containing time data;

providing a plurality of slave clocks, each of the slave clocks receiving time signals which cause the slave clocks to operate in synchronization with a source of the received time signals,

operating at least one of the slave clocks operates using a battery power source, and transmitting a signal representing the battery level value of the slave clock from the slave clock to the master time source for monitoring.

The present invention provides a method of operating a wireless clock system, comprising:

providing a master time source for wirelessly transmitting time signals containing time data at intervals; providing a plurality of slave clocks, each of the slave clocks receiving time signals which cause the slave clocks to operate in synchronization with a source of the received time signals, and transmitting from each of said slave clocks back to said master time source data indicating the number of intervals in which the slave clock has received a time signal.

The present invention provides a method of operating a wireless clock system, comprising:

providing at least one master time source for wirelessly transmitting time signals containing time data in a periodic manner; providing a plurality of slave clocks for wirelessly receiving time signals which cause the slave clocks to operate in synchronization with a source of the received time signals; detecting the number of time periods each slave clock receives the current time signals and transmitting back to the master time source the number of times it receives the current time signals; and comparing information representing when each slave clock receives the time signals during normal operation with when the slave clocks actually receive the current time signals to determine whether the slave clock is operating normally.

The present invention provides a method of operating a wireless clock system, comprising:

providing at least one master time source for wirelessly transmitting time signals containing time data; providing a plurality of slave clocks for wirelessly receiving time signals which cause the slave clocks to operate in synchronization with a source of the received time signals; and

transmitting performance data of each slave clock is back to the master time source for display and monitoring.

The present invention provides a method of operating a wireless system comprising: providing a plurality of master time sources, each master time source wireless transmitting time signals containing time data; providing a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks; and determining the number of repeater slave clocks the time signal passes before being received by the slave clock as a tier value.

The present invention relates to a master and slave clock arrangement having at least two master clocks and a plurality of slave clocks, wherein each slave clock is paired with one master clock. The system is referred to by the assignee as a TalkBack Technology clock system.

In this wireless clock system, the master clock can request and gather information from the slave clocks such as wireless signal quality, battery life, mechanical status, software and hardware version and wireless tier number. This technology utilizes the present assignee's existing wireless clock system mesh network and extends its functionality.

The wireless clock system is designed to work with more than one master clock. Each slave clock is associated, or “paired”, with only one master clock via an internal programmable address that conjoins them and is contained in the slave clock's internal non-volatile memory array.
1) The invention provides a TalkBack Technology wireless clock system composed of a master clock and an analog clock with hour and minute hands that receives time from the master clock and retransmits time to other analog clocks.
   a. The invention provides a TalkBack Technology wireless clock system composed of a master clock that's capable of receiving time from external sources and an analog clock with hour and minute hands that receives time from the master clock and retransmits time to other analog clocks.
   b. The invention provides a TalkBack Technology wireless clock system composed of a master clock that's capable of receiving time from internal sources and an analog clock with hour and minute hands that receives time from the master clock and retransmits time to other analog clocks.
2) The invention provides a TalkBack Technology wireless clock system composed of a master clock and a digital clock with digital segments that receives time from the master clock and retransmits time to other digital clocks.
   a. The invention provides a TalkBack Technology wireless clock system composed of a master clock that's capable of receiving time from multiple sources including NTP, GPS or other time sources and a digital LCD clock with digital segments that receives time from the master clock and retransmits time to other LCD digital clocks.
   b. The invention provides a TalkBack Technology wireless clock system composed of a master clock and a digital LED clock with digital segments that receives time from the master clock and retransmits time to other LED digital clocks.
3) The invention provides a TalkBack Technology wireless clock system composed of a master clock and a combination of analog clocks with hour and minute hands and digital clocks that receives time from the master clock and retransmits time to any of the aforementioned clocks.
   a. The invention provides a TalkBack Technology wireless clock system composed of a master clock and a combination of analog clocks with hour and minute hands, digital LED clocks with digital segments or LCD digital clocks with digital segments that receives time from the master clock and retransmits time to any of the aforementioned clocks.
4) The invention provides a TalkBack Technology wireless clock system that is composed of a master clock that sends/receives time. Many analog clocks that can receive time from the master clock or from any other analog clock, providing a redundancy that allows the analog clock to receive time not only from the master clock, but also from the surrounding analog clocks in its radius.
5) The invention provides a TalkBack Technology wireless clock system that is composed of a master clock that sends/receives time. Many digital clocks can receive time from the master clock or from any other digital clock, providing a redundancy that allows the digital clock to receive time not only from the master clock, but also from the surrounding digital clocks in its radius.
   a. The invention provides a TalkBack Technology wireless clock system that is composed of a master clock that sends/receives time. Many digital LCD clocks that can receive time from the master clock or from any other digital LCD clock, providing a redundancy that allows the LCD digital clock to receive time not only from the master clock, but also from the surrounding LCD digital clocks in its radius.
   b. The invention provides a TalkBack Technology wireless clock system that is composed of a master clock that sends/receives time. Many digital LED clocks that can receive time from the master clock or from any other digital LED clock, providing a redundancy that allows the LED digital clock to receive time not only from the master clock, but also from the surrounding LED digital clocks in its radius.
6) The invention provides a TalkBack Technology wireless clock system that is comprised of a master clock that transmits time and an analog clock that receives time from the master clock. The analog clock then retransmits time to another set of analog clocks that receives time from the original analog clock in such a way that the system can receive time automatically from another clock in the system. Henceforth, if one analog clock fails, the clock automatically receives time from another clock in the system.
7) The invention provides a TalkBack Technology wireless clock system that is comprised of a master clock that transmits time and a digital clock that receives time from the master clock. The digital clock then retransmits time to another set of digital clocks that receives time from the original digital clock in such a way that the system can receive time automatically from another clock in the system. Henceforth, if one digital clock fails, the clock automatically receives time from another clock in the system.
   a. The invention provides a TalkBack Technology wireless clock system comprised of a master clock that transmits time and an LCD digital clock that receives time from the master clock. The LCD digital clock then retransmits time to another set of LCD digital clocks that receives time from the original LCD digital clock in such a way that the system can receive time automatically from another clock in the system. Henceforth, if one LCD digital clock fails, the clock automatically receives time from another clock in the system.
   b. The invention provides a TalkBack Technology wireless clock system comprised of a master clock that transmits time and an LED digital clock that receives time from the master clock. The LED digital clock then retransmits time to another set of LED digital clocks that receives time from the original LED digital clock in such a way that the system can receive time automatically from another clock in the system. Henceforth, if one LCD digital clock fails, the clock automatically receives time from another clock in the system.
   c. The invention provides a TalkBack Technology wireless clock system comprised of a master clock that transmits time and an analog clock, LCD digital clock or LED digital clock that receives time from the master clock. The analog clock, LCD digital clock or LED digital clock then retransmits time to another combination of analog or digital clocks that receives time from the original clock in such a way that the system can receive time automatically from another clock in the system. Henceforth, if one of the analog or digital clocks fails, the clock automatically receives time from another clock in the system.

### BRIEF DESCRIPTION OF THE DRAWINGS

FIGS. 1-5 are timing diagrams illustrating sequences of time signals transmitted by clocks of one embodiment of the present invention:

FIG. 6 is a timing diagram of a second embodiment of the invention, illustrating a sequence of intervals during which a receiver of a slave clock is “opened” or activated;

FIG. 7 is a timing diagram of the second embodiment of the invention, illustrating a normal operation of a receiver of a slave clock;

FIG. 8 is a timing diagram of another embodiment of the invention, illustrating transmission of signals by a transceiver of a slave clock;

FIG. 9 is a block diagram of a transceiver circuit used in the invention; and

FIG. 10 shows a tabulation of clock times displayed at three clocks over a 24-hour period, showing the ability of slave clocks of the present invention to adjust themselves to time changes at a master clock;

FIG. 11 shows a multiple master clock arrangement with multiple slave clocks, wherein each slave clock is “paired” with a single master clock and responds to time signals only from that associated master clock;

FIG. 12 shows a master clock with an associated display with interface capability;

FIG. 13 shows a master/slave clock arrangement wherein slave clocks send their battery level signal to the master clock, and wherein the master clock stores and displays (either directly or through a web-based connection to a computer) the battery level for each slave clock in spreadsheet format, wherein any column parameter can be selected for recording from highest to lowest (or vice versa), or other characteristic;

FIG. 14 shows a master/slave clock arrangement wherein slave clocks send their signal strength percentage (%) (the number of time signals that the slave clock receives compared to the number of time signals which were transmitted) to the master clock, and wherein the master clock stores and displays (either directly or through a web-based connection to a computer) the signal strength percentage in spreadsheet format, wherein any column parameter can be selected for recording from highest to lowest (or vice versa), or other characteristic;

FIG. 15 shows a master clock with slave clocks, wherein the slave clocks transmit mechanical slave clock status to the master clock, and the master clock has an associated display, which may be over the web, to display mechanical clock status, such as mechanical clock failures, an example being hand failure; and

FIG. 16 shows a master clock with slave clocks, wherein the slave clocks transmit information to the master clock, such as, location, RX quality (the number of time signals that the slave clock receives compared to the number of time signals which were transmitted), tier number (the number of repeater slave clocks the time signal passes before being received by the slave clock), battery level, and mechanical status, and the master clock has an associated display which displays the information in spreadsheet format, with the user able to select a column for recording the data.

### DETAILED DESCRIPTION OF THE PREFERRED EMBODIMENT

One or more embodiments will be described, but the invention is not limited to the embodiments.

As used herein, the term “slave clock” is used to refer to any instrument that operates as a “repeater” or relay device to receive time signals from another source of time data, and then to transmit its own time signals containing the time data to other instruments. The instrument may, but need not, be a “clock” in the traditional sense, namely a device having analog hands or a digital or other display device that physically displays the time.

As used herein, the term “display clock” refers to a clock in the traditional sense, namely a device having analog hands or a digital or other display device that physically displays the time.

As used herein, the term “talkback” refers to the feature of a clock being able to transmit status, performance or operation information, such as signal strength, battery level, associative pairing with one or more other clocks, time change adjustment, amount of time adjustment, master time source data indicating the number of intervals in which in the slave clock has received a time signal, tier value, software version, hardware version, and mechanical operation of the slave clock display, such as hand or display failure, for example.

As used herein, the term “tier value” means the number of repeater slave clocks the time signal passes before being received by the slave clock.

According to one embodiment of the present invention, the invention comprises a wireless clock system that normally includes one master time source, such as a master clock, and one or more secondary or “slave” clocks. Preferably, more than one slave clock is used. The clocks may be installed in a large facility where the physical distances between the clocks may be large.

Each secondary clock in the system includes a transceiver that both receives and transmits time signals. The time signals include or represent current time data. This data is preferably based on or obtained from a highly accurate master time source that includes current time data, and in some cases data representing the status of the current time base of the master clock.

One advantage of such a system is that the system is not limited to the distance between the master clock and the secondary clocks, because each secondary clock may be configured to operate as a “repeater” for transmitting or re-transmitting time signals to other secondary clocks. Thus, it is not necessary for every secondary clock to be installed within wireless receiving range of the master clock, as long as each secondary clock is within range of at least one other secondary clock, or within range of an external wireless source of time data.

A wireless clock system, comprising: a master clock; and an analog clock with hour and minute hands that is capable of receiving a time signal from the master clock and retransmitting a time signal to other analog clocks.

A wireless clock system, comprising: a master clock that is capable of receiving a time signal from external sources; and an analog clock with hour and minute hands that is capable of receiving a time signal from the master clock and retransmitting a time signal to other analog clocks.

A wireless clock system, comprising: a master clock that is capable of receiving a time signal from internal sources; and an analog clock with hour and minute hands that is capable of receiving a time signal from the master clock and retransmitting a time signal to other analog clocks.

A wireless clock system, comprising: a master clock; and a digital clock with digital segments that is capable of receiving a time signal from the master clock and retransmitting the time signal to other digital clocks.

A wireless clock system, comprising: a master clock that is capable of receiving a time signal from multiple sources including at least NTP and GPS sources; and a digital LCD clock with digital segments that is capable of receiving a time signal from the master clock and retransmitting a time signal to other LCD digital clocks.

A wireless clock system, comprising: a master clock; and a digital LED clock with digital segments that is capable of receiving a time signal from the master clock and retransmitting the time signal to other LED digital clocks.

A wireless clock system, comprising: a master clock; and a combination of analog clocks with hour and minute hands and digital clocks that are capable of receiving a time signal from the master clock and retransmitting a time signal to other clocks.

A wireless clock system, comprising: a master clock; and a combination of analog clocks with hour and minute hands, digital clocks that are capable of receiving a time signal from the master clock and retransmitting a time signal to other clocks.

A wireless clock system, comprising: a master clock capable of transmitting and receiving a time signal; and a plurality of analog clocks that are capable of receiving time signals from the master clock or from other analog clock, providing a redundancy that allows the analog clock to receive a time signal from the master clock, as well as other analog clocks within its range.

A wireless clock system, comprising: a master clock that is capable of transmitting and receiving a time signal; and a plurality of digital clocks that are capable of receiving a time signal from the master clock or from another digital clock, providing a redundancy that allows the digital clock to receive a time signal from the master clock, as well as other digital clocks within its range.

A wireless clock system, comprising: a master clock that is capable of transmitting and receiving a time signal; and a plurality of digital LCD clocks that are capable of receiving a time signal from the master clock as well as another digital LCD clock, providing a redundancy that allows the LCD digital clock to receive a time signal from the master clock, as well as a time signal from other LCD digital clocks within its range.

A wireless clock system, comprising: a master clock that is capable of transmitting and receiving a time signal; and a plurality of digital LED clocks that are capable of receive a time signal from the master clock as well as another digital LED clock, providing a redundancy that allows the LED digital clock to receive a time signal from the master clock, as well as other LED digital clocks within its range.

A wireless clock system, comprising: a master clock that is capable of transmitting a time signal; and an analog clock that is capable of receiving a time signal froth the master clock, and retransmitting a time signal to a plurality of analog clocks that are capable of receiving a time signal from the analog clock, whereby each analog clock is capable of receiving a time signal automatically from any other analog clock in the system.

A wireless clock system, comprising: a master clock that is capable of transmitting a time signal; and a digital clock that is capable of receiving a time signal from the master clock, and retransmitting the time signal to a plurality of digital clocks that are capable of receiving time from the digital clock, whereby each digital clock is capable of automatically receiving a time signal from any other digital clock in the system.

A wireless clock system, comprising: a master clock that is capable of transmitting a time signal; and a first LCD digital clock that is capable of receiving a time signal from the master clock, and retransmitting the time signal to a plurality of LCD digital clocks that are capable of receiving a time signal from the first LCD digital clock, whereby each LCD digital clock is capable of receiving a time signal automatically from another LCD digital clock in the system.

A wireless clock system, comprising: a master clock that is capable of transmitting a time signal; and a first LED digital clock that is capable of receiving a time signal from the master clock, and retransmitting a time signal to a plurality of LED digital clocks that are capable of receiving a time signal from the first LED digital clock, whereby each LED clock is capable of automatically receiving a time signal from any other LED clock in the system.

A wireless clock system, comprising: a master clock that is capable of transmitting a time signal; and at least one of an analog clock, LCD digital clock or LED digital clock that is capable of receiving a time signal from the master clock, said at least one clock being capable of retransmitting a time signal to any other clock that is capable of receiving a time signal from the master clock, whereby any clock is capable of receiving a time signal automatically from any other clock in the system.

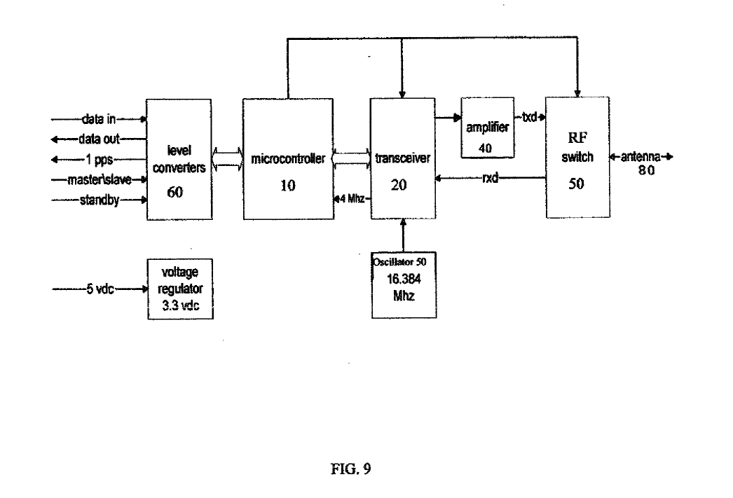

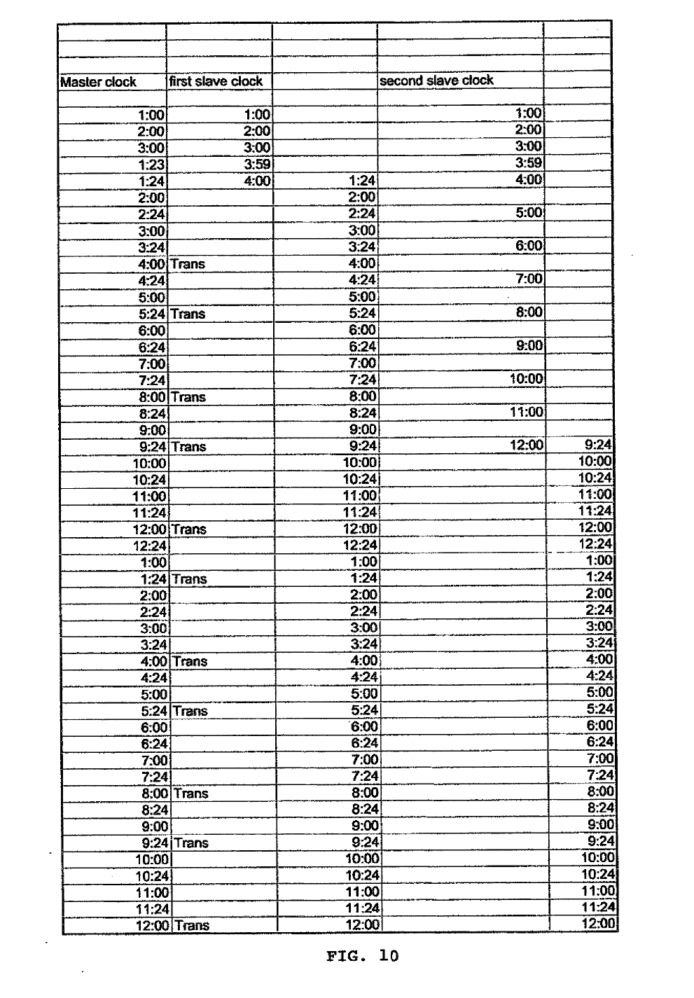

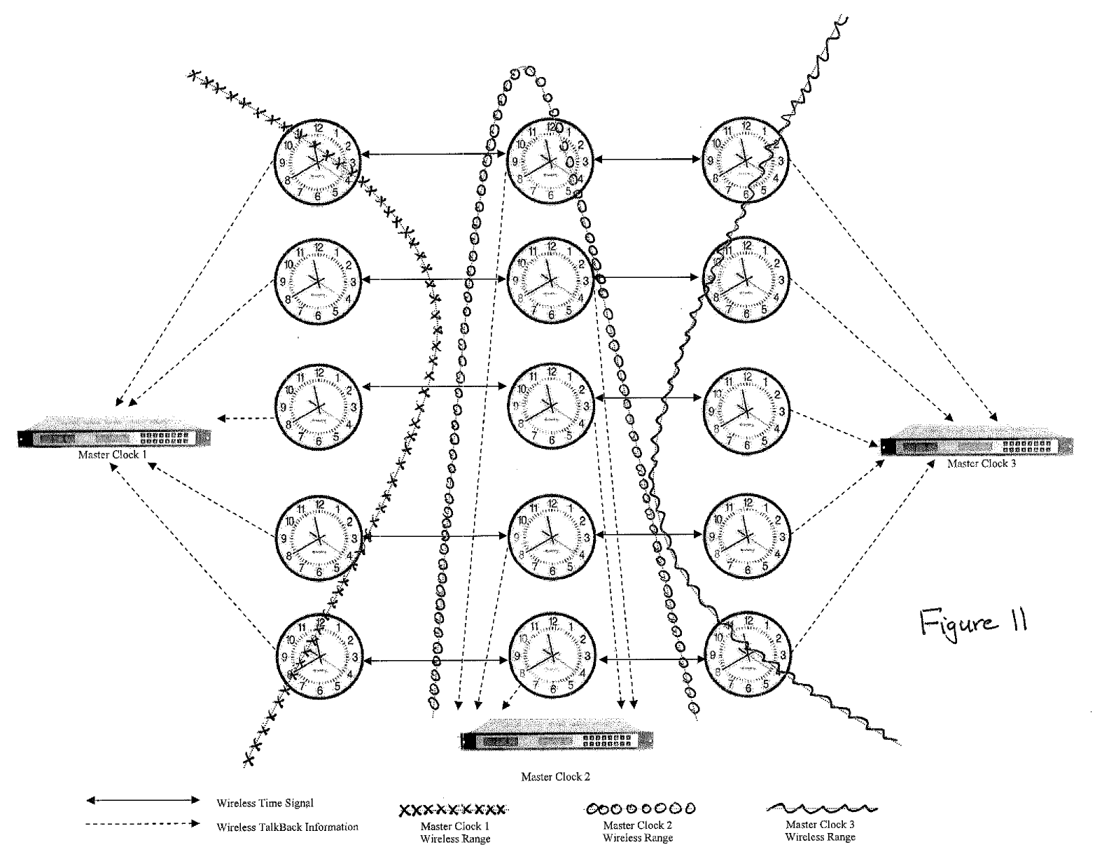

A block diagram of a preferred embodiment of the invention is shown in FIG. 9. The invention includes a microcontroller 10 coupled to and controlling a transceiver 20. Preferably, transceiver 20 is a frequency shift keying (FSK) transceiver that includes both a receiver portion or operating mode, and a transmitter portion or operating mode, and operating at radio frequency (RF).

The microcontroller 10 causes the transceiver 20 to receive and transmit time signals usually alternately, preferably in a frequency hopping manner. The frequencies are preferably within a preselected range, such as the 915-928 MHz frequency range. The microcontroller controls the direction of signals from the antenna by an RF switch 50. When the transceiver transmits, signals come out from the microcontroller to the transceiver, and from the transceiver to an amplifier 40. From the amplifier the signals move through the RF switch to an antenna 80. When the transceiver receives, the signals come from the antenna to the RF switch to the transceiver and from it to the microcontroller.

In an alternative embodiment, the microcontroller may be configured to cause the transceiver to either continuously receive or continuously transmit signals.

Preferably, the present invention operates under software control. The software is stored in a memory unit (not shown) contained within or coupled to microcontroller 10 (FIG. 9). Microcontroller 10 may be programmed from the outside with data sent through a link passing through level converters 60.

In FIG. 9, several data lines are shown coupled to the circuit element labeled level converters 60. The “data-in” line receives time data from a source such as another microcontroller (not shown). This time data operates or controls the slave clock's time base, or internal time, which runs continuously. The time data also is later encoded into time signals that are subsequently transmitted over antenna 80 by transceiver 20 when the transceiver is in transmit mode.

The “data-out” line carries time signals generated by microcontroller 10 to an analog movement or other display device (not shown) that displays the slave clock's internal time, if the slave clock is being used as a physical clock. Otherwise, if the slave clock is only being used as a repeater device, the movement or display device is not necessary; nothing is displayed; and the data out line is not necessary.

The “1 pps” line is used to generate “ticks”, namely to move an analog second hand forward by one pulse per second, if an analog movement is included with the slave clock. Otherwise, if the slave clock is only being used as a repeater device, the “pps” line is not necessary.

The “master\slave” line sends data that causes the transceiver to either transmit signals (while in temporary master mode) or to both receive and send signals (while in slave mode). In other words, the “master\slave” input defines the mode of operation. This line can be connected to a switch that, when activated, causes the device to assume the role of “master clock” temporarily. In one example, an applied voltage of 0 v may represent master mode, and an applied voltage of 5 v may represent slave mode. The microcontroller reads the “master\slave” input to decide in which mode it operates. When it is in master mode, it uses its UART (universal asynchronous receiver-transmitter) to receive the data coming through its “data-in” input at various baud rates.

The “standby” line is used if an operator wishes to shut down the slave clock.

Preferably, the invention has two modes of operation, as follows:
1. Master—Transceiver: In this mode the device receives time signals through its serial communication input (“data in”), and transmits an RF message every 1 minute through its antenna.
2. Slave—Repeater: In this mode the device receives time signals through its antenna, amplifies the signals, and transmits them to the antenna.

Preferably, the master clock wirelessly transmits a time signal once per minute, and each slave clock wirelessly transmits a time signal once every four hours. Other intervals could, of course, be used instead, if desired.

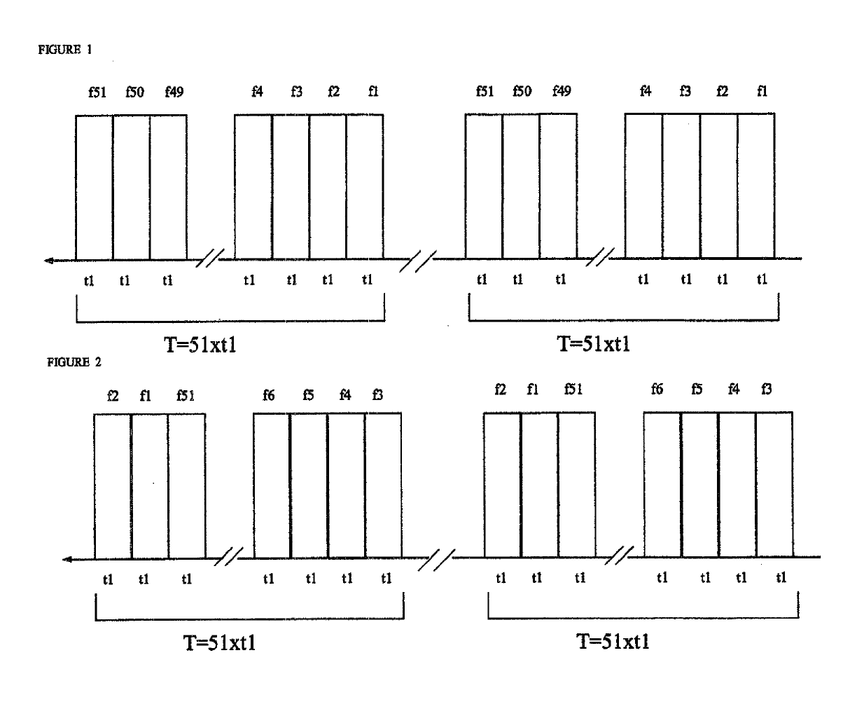

Turning next to FIG. 1, in a preferred embodiment, the master clock and all of the secondary clocks transmit data representing time signals over 51 different preselected frequencies in the range of, for example, 915 MHz to 928 MHz. Preferably, these frequencies are preselected during or before the manufacture of the slave clock, and are either hard-wired into the slave clock or stored in a memory (not shown) within the slave clock.

Time signals are transmitted in a series of “frames” of data (“f1”, “f2”, etc.) having periods (“t1”) of equal duration, for example 10 milliseconds each. The flow of time in FIG. 1 is illustrated by the horizontal arrow, the direction of flow being from right to left.

In a feature of the invention, each frame of data is transmitted over a different frequency in a pseudo-random frequency-hopping manner. Each frequency is randomly chosen from among the 51 different preselected frequencies mentioned above. This “hopping” is preferably “back and forth” rather than uniformly increasing or decreasing. For example, the first frame f1 may be transmitted at 916 MHz, frame f2 may be transmitted at 917 MHz, frame f3 may be transmitted at 915 MHz, and so on out to frame f51. In this example, as shown in FIG. 1, since each frame of data is 10 milliseconds long per each frequency, the total transmission time (“T”) is 0.51 seconds, representing 51 frequencies times 10 milliseconds per frequency, or in other words “T=51.times.t1”.

In order to avoid interference among all the secondary clock units that are transmitting time, and in another feature of the invention, each unit starts the transmission at a random frequency. For example, FIG. 1 shows a unit that starts transmitting in frequency 1 (f1) and ends the transmission of a set of data in frequency 51 (f51), while FIG. 2 shows a different unit that starts transmitting in frequency 3 (f3) and ends the transmission in frequency 2 (f2). The order of hopping from one frequency to another may either be the same in all units, or may be pseudo-randomly chosen from among the 51 preselected frequencies. All 51 frequencies are used. In this manner, the slave clocks avoid interrupting or interfering with each other.

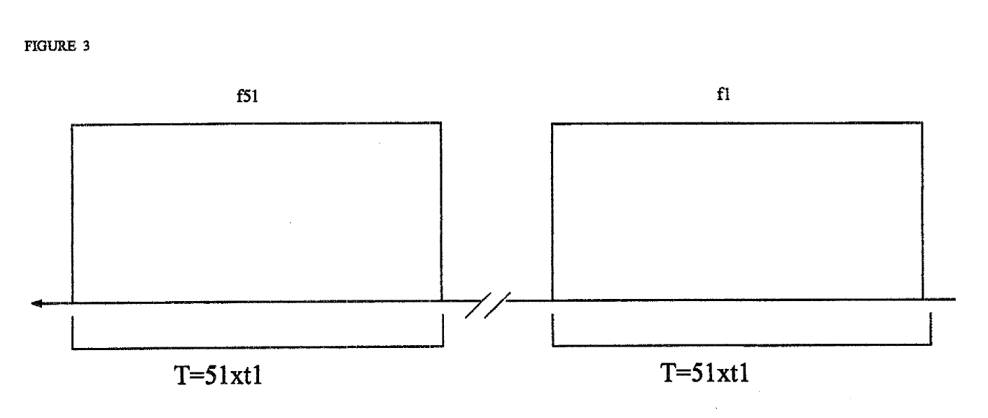

Looking next at FIG. 3, the receiver portion of the transceiver in each secondary clock unit is tuned to the first frequency for a total time of 0.51 (T) seconds to insure receiving data in this specific frequency. If, however, valid time data is not received for some reason, the receiver will hop or jump to the next frequency and the microcontroller 10 (FIG. 9) in each unit will “open” or activate the receiver again for 0.51 (T) seconds and will continue to do so until it receives valid data. FIG. 3 shows that the receiver is open in frequency 1 (f1) for total time of T and will, if necessary, continue hopping from one frequency to another until ending at frequency 51 (f51).

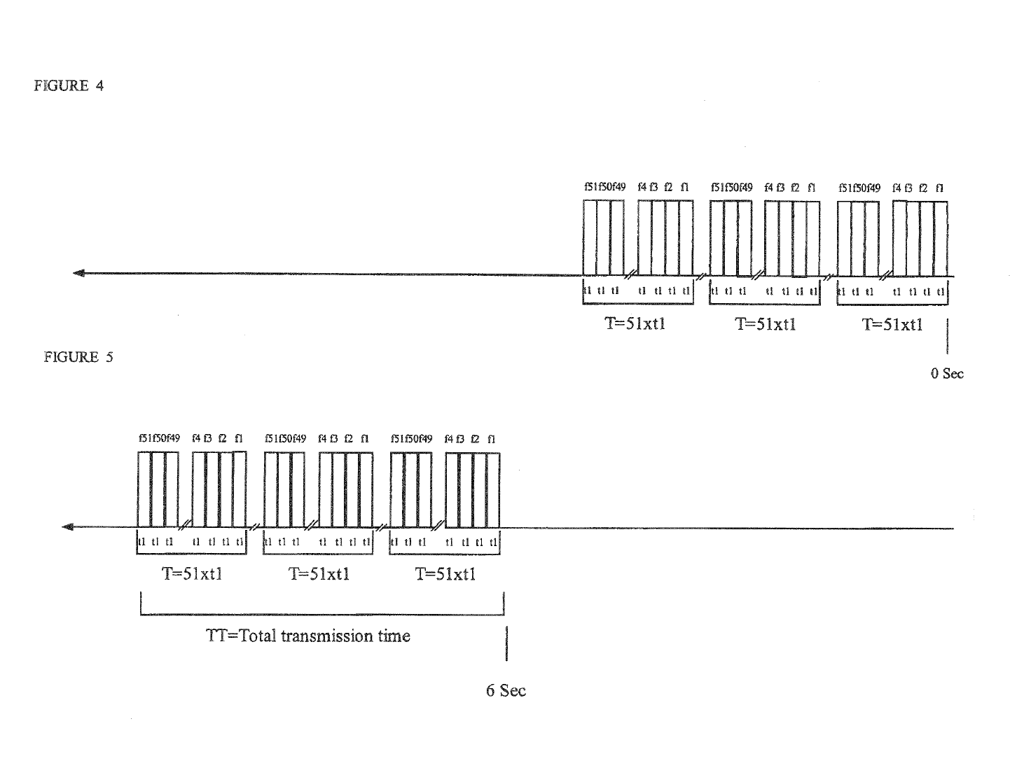

In yet another feature of the invention, in order to avoid interruption or interference between two units that start transmission in the same frequency, each unit will also be randomly or pseudo-randomly shifted in time from each other. In other words, the time of the start of transmission of time signal data is randomly or pseudo-randomly initiated from within a preselected range of starting time points. For example, if the total transmission time is 0.51 (T) seconds, and the unit transmits 10 sets of data in all 51 frequencies, the grand total of transmission time in this example is 5.11 seconds. This means that if the unit pseudo-randomly transmits in 6-second intervals from each other, this ensures that there will be no interference with each other. FIG. 4 shows a transceiver that started transmitting at 0 time and FIG. 5 shows a transceiver that started transmission six (6) seconds later. It can clearly be seen that there is no overlap or interference between these two transmissions.

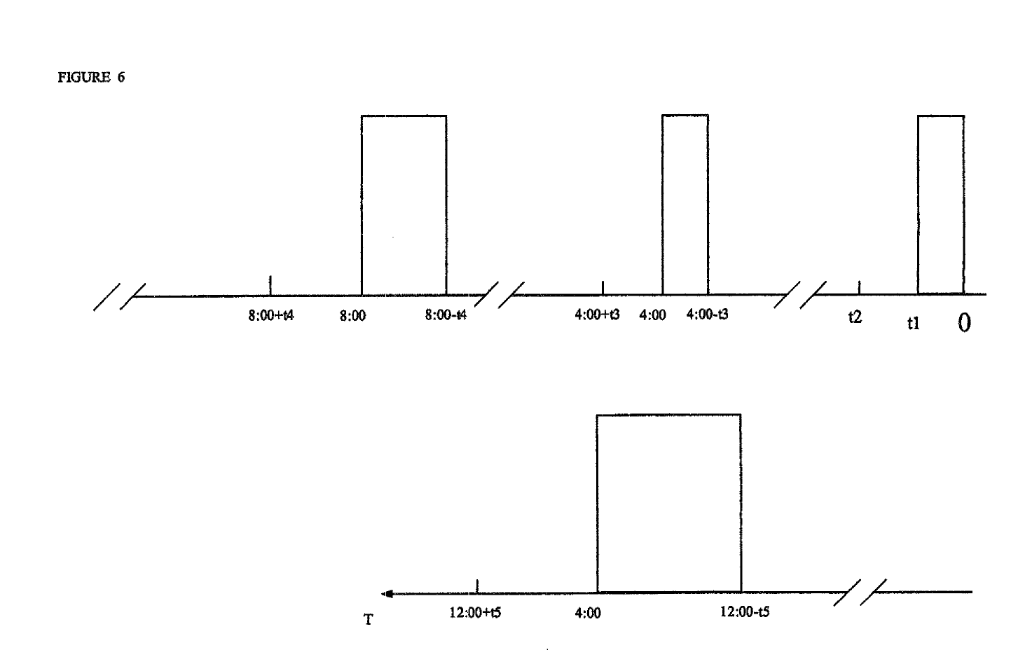

FIGS. 6-8 illustrate a second embodiment of the invention. This embodiment relates to a wireless master-slave clock system in which each slave clock includes a transceiver that may be battery-powered. In one embodiment, in order to minimize battery power consumption, the microcontroller 10 in each unit “opens” or turns on the receiver portion of its transceiver for the receipt of wireless data upon initial power up, and then at specific times thereafter, such as every four (4) hours, for example at 12:00 o'clock, 4:00 o'clock and 8:00 o'clock.

A potential concern that may arise in this arrangement is when the battery-operated slave clocks are installed first in the absence of an operating master clock. Upon later installation of the master clock, which could be either AC-powered or battery-powered, the master clock will start transmitting continuously and the slave clocks will open their receivers upon power up and at fixed times thereafter and then will synchronize themselves with the master. However, in case a transceiver is out of the receiving range of signals from the master clock, or is in a noisy environment, the slave clock will not receive time signals, or will receive invalid time signals, from the master clock.

To address this concern, and in a feature of the invention, in order for the out-of-range slave clocks to be Synchronized with the rest of the system (the master clock and the in-range slave clocks within receiving distance of either the master clock or another slave clock), their receivers must be opened together at the same time that the other transceivers are transmitting time signal data.

As an example, assume that the system includes one master clock, one in-range slave clock and one out-of-range slave clock. In order to enable the first synchronization after the in-range clock has received valid data, an operator pushes or otherwise activates a switch or other control at both the in-range clock that received valid data and the out-of range clock that did not receive valid data. Upon pushing the switch, the unit that did receive the valid data will start transmitting or re-transmitting the data, and the unit that did not receive the valid data will open its receiver in order to receive the valid data. When this event happens, both clocks will be synchronized together, and each clock will then open its transceiver to both receive and transmit every 4 hours thereafter, such as at 12, 4 and 8 o'clock.

Every slave clock checks to see if it has received valid data in the last 12 hours. If so, the clock opens its receiver to receive data for a period of time, and then re-transmits that data for a period of time. The process is repeated until the unit has received valid time data. At that point, the unit switches to a transmit mode only, or the unit will reach time out and will repeat the process 4 hours later.

This embodiment may be used with both battery-powered and AC-powered clocks, where the transceivers are constantly jumping from receiving to transmitting modes.

FIG. 6 shows periods during which the receiver portion of a transceiver in a secondary clock unit is open for data reception. At time 0 (near the right-hand side of FIG. 6), the receiver is opened. If at time t1, the receiver receives valid data, the transceiver is closed or deactivated. If, however, valid data was not received within this period, the reception “window” is opened up again (or kept open) to time t2 and then closes. If valid data is still not received, then at a later time, say 4 o'clock, the “window of opportunity” is opened again at 4 o'clock.+−.t3. However, if the clock still has not received valid data at 4 o'clock plus t3, then at shortly before 8 o'clock, the receiver is opened for reception for a longer duration of up to .+−.t4, a “window” of reception that is greater than .+−.t3. If the receiver still does not receive valid data at 12 o'clock, the slave clock will open the receiver up to .+−.t5, a window that is greater than As can be seen, the “window of opportunity” for the receipt of valid data keeps getting larger (up to a point) until the receiver receives valid data. At this point, the entire system is synchronized. The window then returns to its original narrow width at subsequent times.

Another feature of the invention relates to calibration. Calibration refers to adjustment of a clock's time base, which is different from synchronization. Calibration is important because, even if two clocks have been synchronized, then the clocks will quickly become unsynchronized again unless they are calibrated. One way to calibrate a clock is to slightly speed up or slow down the length of a second or other unit of time measured by the clock, to compensate for “drift” in the time base or internal time of the clock, as compared with another clock's time base. Drifting time bases are of particular concern when batteries are used as a power source for slave clocks, because some battery-powered clocks have a tendency to slow down as the battery is drained. Calibration of time drift is also important for non-battery-operated clocks.

In the present invention, and looking at FIG. 6, in order to maintain an adequate calibration among all clocks, and to further minimize battery power consumption, each slave clock performs a digital calibration on its time base each time the “window of opportunity” is opened and closed, namely at 4 o'clock, 8 o'clock and 12 o'clock in the example shown in FIG. 6. This ensures that the clock's transceiver will be open to receive time signals for a short time at the expected transmission time.

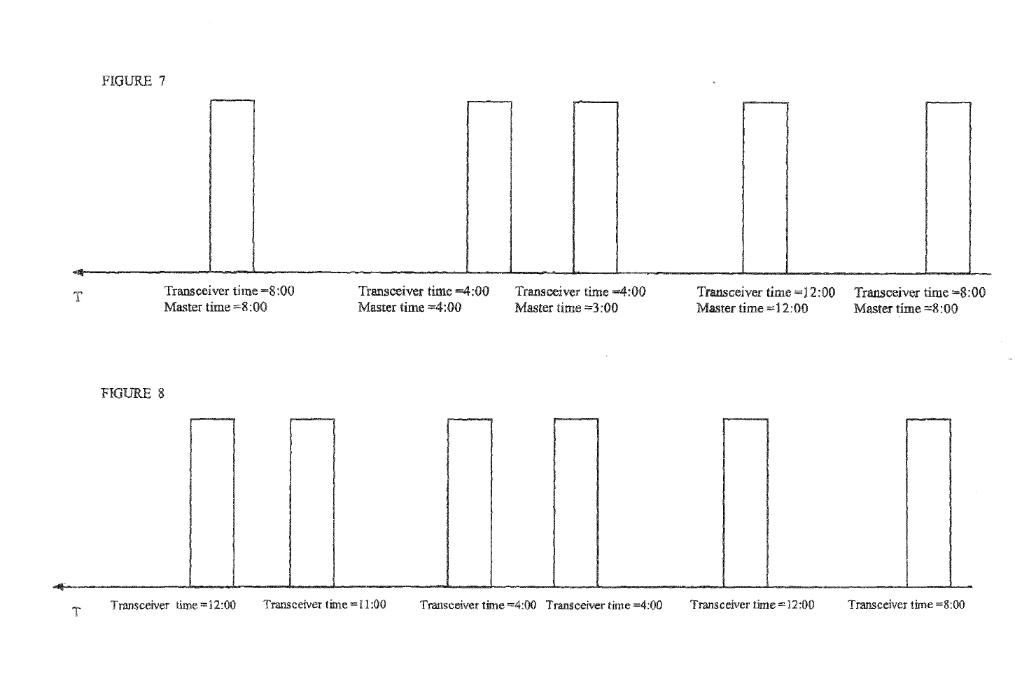

In yet another feature of the invention, the system disclosed herein can properly account for daylight savings time changes, or any other time changes or differences between the master clock and a slave clock, or between two slave clocks. Turning now to FIG. 7, this figure illustrates a normal operation of the receiver portion of one of the transceivers. At time t1 the transceiver time at a secondary clock is 8 o'clock and receives valid data from a master clock (or from another secondary clock) representing a time of 8 o'clock. Four hours later, the transceiver time is 12 o'clock and receives a valid time of 12 o'clock. Four hours later, the transceiver time is 4 o'clock; however, it receives a valid time of 3 o'clock (for example, daylight savings time). The transceiver then updates its time base for 3 o'clock and an hour later it opens its receiver again. The transceiver opens its receiver again an hour later. At this point, the secondary clock time will be set to 4 o'clock again, which now agrees with the correct time of 4 o'clock at the master clock. Thus, synchronization has been achieved even during periods of daylight savings time adjustment.

FIG. 8 shows the transmission of time signals by the transceiver. While the transceiver time is 8, 12 and 4 o'clock, the transceiver will transmit every 4 hours. However, if the transceiver time is changed by valid data, for example from 4 to 3 in a daylight savings time shift, the transceiver will transmit both the “old” time and the “new” time for some period. For example, as shown in FIG. 8, a transceiver transmits time signals at 4, 8 and 12 o'clock, as well as at 11, 3 and 7 o'clock. Preferably, this process continues for a period of three days, to ensure that all clocks in the system are synchronized and are receiving valid time data.

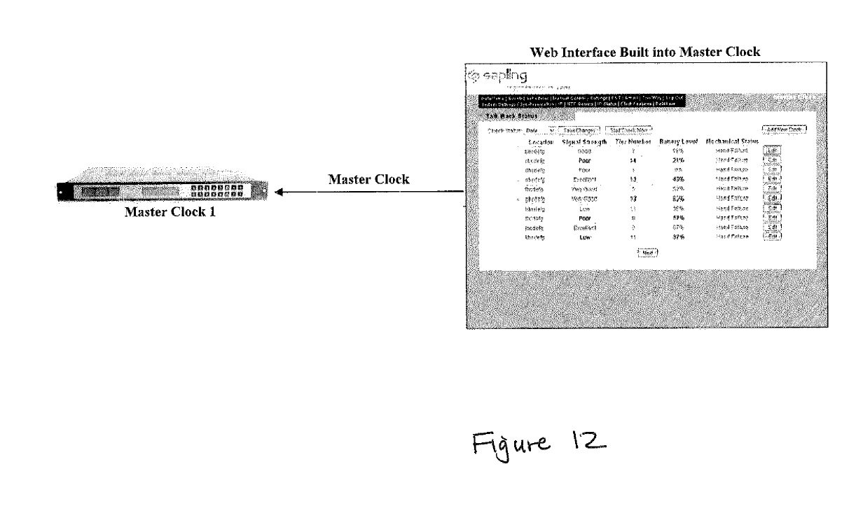

The above-described “window opening and closing” aspect of the invention has many advantages, and is further illustrated in FIG. 10. This figure shows a tabulation of clock times displayed at a master clock and two slave clocks over a 24-hour period, showing the ability of slave clocks of the present invention to adjust to time changes at a master clock, and the ability of a slave clock to recover from temporary interruptions in wireless signal reception. In this example, the master clock is wirelessly transmitting a normal time signal once per minute.

Starting at 1 o'clock, it can be seen that all three clocks are displaying the correct, identical time. In other words, both slave clocks are in synchronization with the master clock. The clocks continue in synchronization as the clocks reach 2 o'clock and 3 o'clock.

Shortly after 3 o'clock, in this example, someone manually changes the time at the master clock to 1:24 o'clock, for whatever reason. (For example, the master clock might be out of adjustment.) This may be called the “new” time. The time of this change is stored in a memory at the master clock. Now, the master clock transmits its normal minute-by-minute time signal. Meanwhile, the first slave clock, still “thinking” it is 4 o'clock, opens its receiver because, as discussed above, it is programmed to automatically open its receiver at 4, 8 and 12 o'clock. The first slave then receives the time signal from the master saying the “new” time is 1:24. The first slave then corrects its time to the “new” time of 1:24, and stores the time of this change in a memory at the slave clock. The first slave then retransmits this time data to the second slave. But for whatever reason, the second slave does not receive the signal, and the second slave continues to “think” it is 4:00, and continues to display its “old” time. At this point, the first slave is in synchronization with the master, but the second slave is out of synchronization.

Later, at 4:00, the first slave opens its receiver and receives a transmission of time data from the master. Still later, at 5:24, the first slave opens its receiver again, and receives time data from the master. The reason the receiver is opened again is that 4 hours have elapsed since the time the master clock was changed, namely 1:24. Thereafter, the first slave opens its receiver twice every 4 hours. The first “opening” occurs when the displayed clock time shows 4, 8 and 12 o'clock. The second opening occurs when 4 hours have elapsed since the time of the last “correction”. Meanwhile, the second slave clock continues to open its receiver when its own displayed time shows 4, 8 and 12 o'clock, but the second slave is not receiving valid time data from either the master or the slave, for whatever reason.

Two other openings of the first slave's receiver occur later at 8:00 and 9:24. At this point, the time displayed at the second slave shows 12:00. Now, in this example, suppose the second slave suddenly starts to receive valid wireless time signals from the first slave at 9:24. The second slave immediately corrects its time from 12:00 to 9:24, because it assumes that the first slave is showing the “correct” time. At this point, all three clocks are in synchronization. Also, the system has been able to recover from a temporary loss of valid wireless reception. All clocks will remain in synchronization at all times thereafter, as long as each slave clock is within wireless reception range of either the master clock or at least one other slave clock.

The frequency and timing of the opening and closing of the transmitter and receiver portions of the transceiver 20 is preferably under software control. In addition, microcontroller 10 generates pseudo-random numbers, or performs a table look-up, to randomize the transmission frequencies from among the preselected range of frequencies and to randomize the start times of the time signal transmissions from among the preselected range of starting time points.

In another embodiment of the invention, a separate physical master clock is not needed. Rather, some other master time source may be used, such as a cellular telephone tower or other facility; a global positioning satellite (GPS) facility; a wireless facility broadcasting time data obtained over the Internet; a radio facility broadcasting time signals from an atomic clock, etc. For example, each slave clock may be configured to receive time signals from a cellular telephone tower antenna. In this embodiment, the cell phone tower substitutes for the master clock, because cell phone signal transmissions normally include a very accurate time component. In yet another embodiment of the invention, the invention does include a separate master clock, and the master clock receives time signals from the cell phone tower as well.

The master clock can send two different transmissions: time/date or a request for data. If each case, the slave clock upon receipt will resend the signal as a repeater for use by other slave clocks.

If the master clock sends a request for data, it will send a request with the desired slave clock range (e.g., slave clocks 10-19) and the master clock's own number. Each slave clock, when receiving the data request, will determine whether that slave clock is paired with this master clock. If not, the slave clock will turn off its receiver and ignore the request. If yes, then the slave clock will determine whether it needs to repeat the signal to get back to the master clock. For example, if the master clock is capable of polling a system of 100 clocks, and is looking for data from clocks designated numbers 10-19, the master clock sends out a request for data telling the slave clocks that master clock is polling those slave clocks designated numbers 10-19. Each slave clock, knowing its own designated number and how many slave clocks are being polled, will determine by itself its own designated interval of time or time window its receiver needs to stay open.

Each slave clock transmits approximately every 30 seconds. Hence, for 10 clocks, the receiver will be open approximately 5 minutes (10×30 seconds=5 minutes). If the slave clock is one of the clocks numbered 10-19, the slave clock will determine by itself where the clock is in the receiver time frame, and will define its designated time window within which to respond. For example, Clock #10, being the first clock in the polling range, will transmit its response within a designated window between 00:00:00-00:00:30 from when it received the request for data. Clock #11, which knows it is the second clock in the polling range, will transmit its response within its designated window between 00:00:30-00:01:00 of when it received its request for data, which is the second 30 second interval available. Clock #12, which knows that it is the third clock in the polling range, will transmit its response within its designated window between 00:01:00-00:01:30, etc., all the way to clock #19. Each clock will define its own time window based on when it received its request for data, and where it lies in the polling range. For this operation, time of day is not relevant and has no bearing on determining the designated time window for each clock. All each slave clock uses to determine its own time window is, after it receives its request for data, where that slave clock is in the polling order.

All 100 clocks in the entire system will be participating in the repeating process. They all know they will need to be repeating for approximately 5 minutes. When a clock receives a response from clock 10 ten (10) seconds into its own determined time interval, it will close its receiver for the remainder of the 30 second time interval, in order to conserve battery power because it know that only one response will be sent every 30 seconds.

If the slave clock in question is clock 13, it knows it must send its status within its self-determined designated time window 00:01:30-00:02:00 after it receives its request for data. Once clock 13 sends its status, clock 13 goes back to repeating for the remaining of the clocks in the range (clocks 14-19).

After a complete five minute interval, all 100 clocks will go back to normal operation. The data is sent back from clock to clock to clock in repeater fashion to the master clock, in the same way that it got there originally, using frequency hopping as described above.

FIG. 11 shows a multiple master clock arrangement with multiple slave clocks, wherein each slave clock is “paired” with a single master clock and responds to time signals only from that associated master clock.

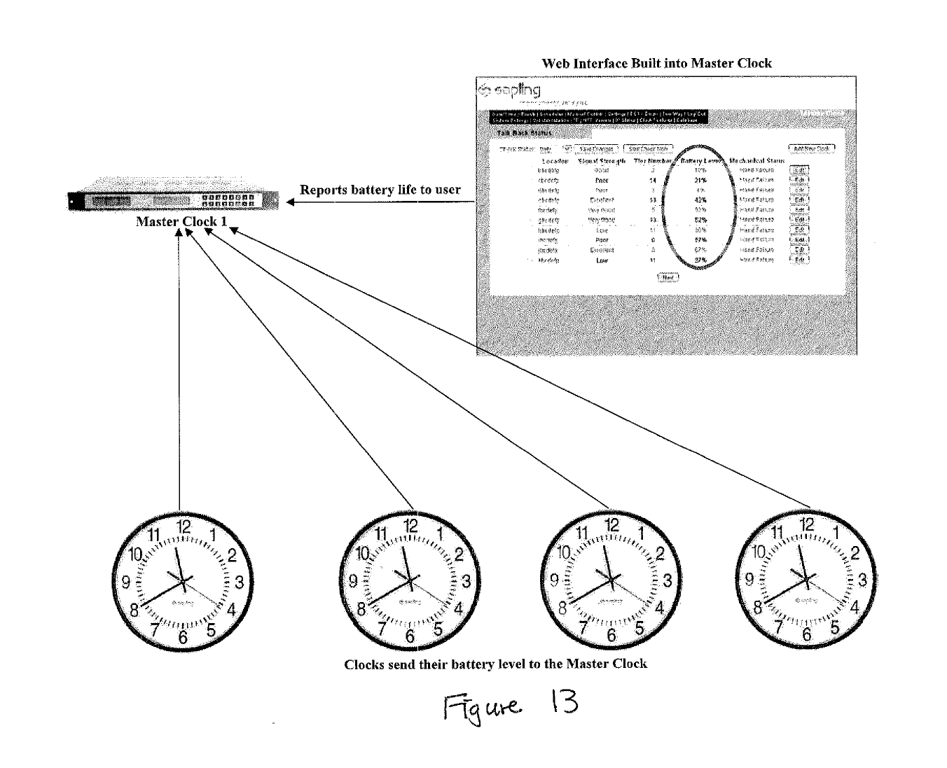

FIG. 12 shows a master clock with an associated display with interface capability, such as through a web-based connection over the interne.

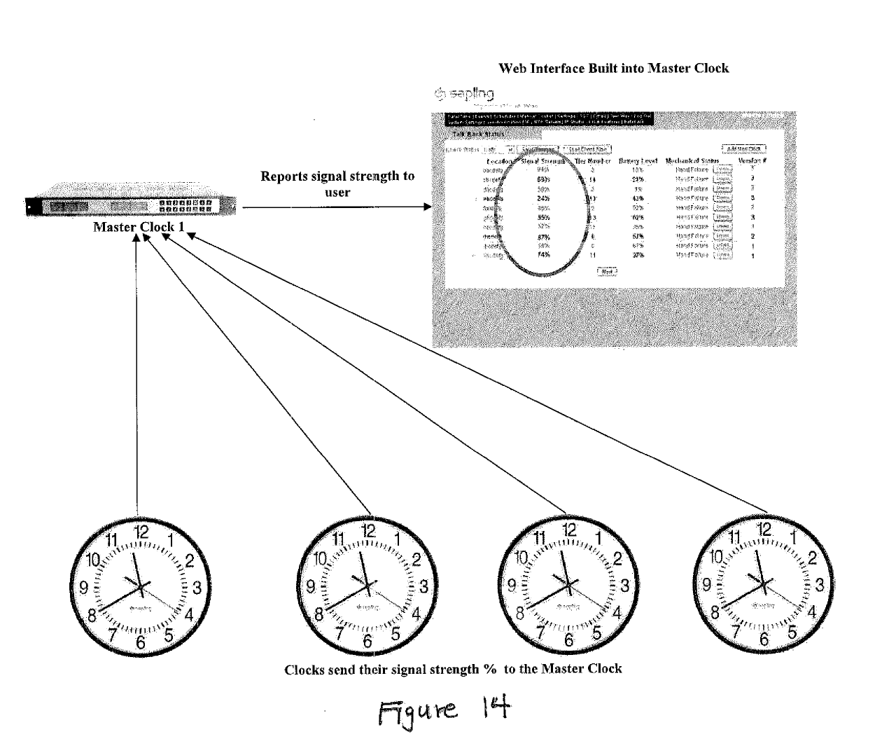

FIG. 13 shows a master/slave clock arrangement wherein slave clocks send their battery level signal to the master clock, and wherein the master clock stores and displays (either directly or through a web-based connection to a computer) the battery level for, each slave clock in spreadsheet format, wherein any column parameter can be selected for recording from highest to lowest (or vice versa), or other characteristic.

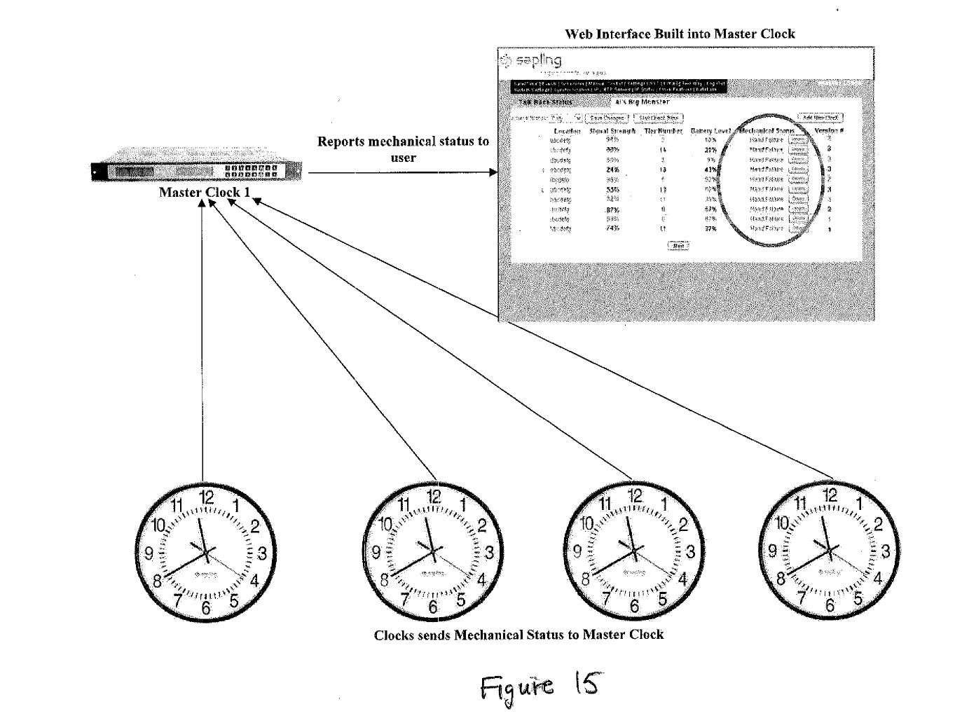

FIG. 14 shows a master/slave clock arrangement wherein slave clocks send their signal strength percentage (%) (the number of time signals that the slave clock receives compared to the number of time signals which were transmitted) to the master clock, and wherein the master clock stores and displays (either directly or through a web-based connection to a computer) the signal strength percentage in spreadsheet format, wherein any column parameter can be selected for recording from highest to lowest (or vice versa), or other characteristic.

FIG. 15 shows a master clock with slave clocks, wherein the slave clocks transmit mechanical slave clock status to the master clock, and the master clock has an associated display, which may be over the web, to display mechanical clock status, such as mechanical clock failures, an example being hand failure.

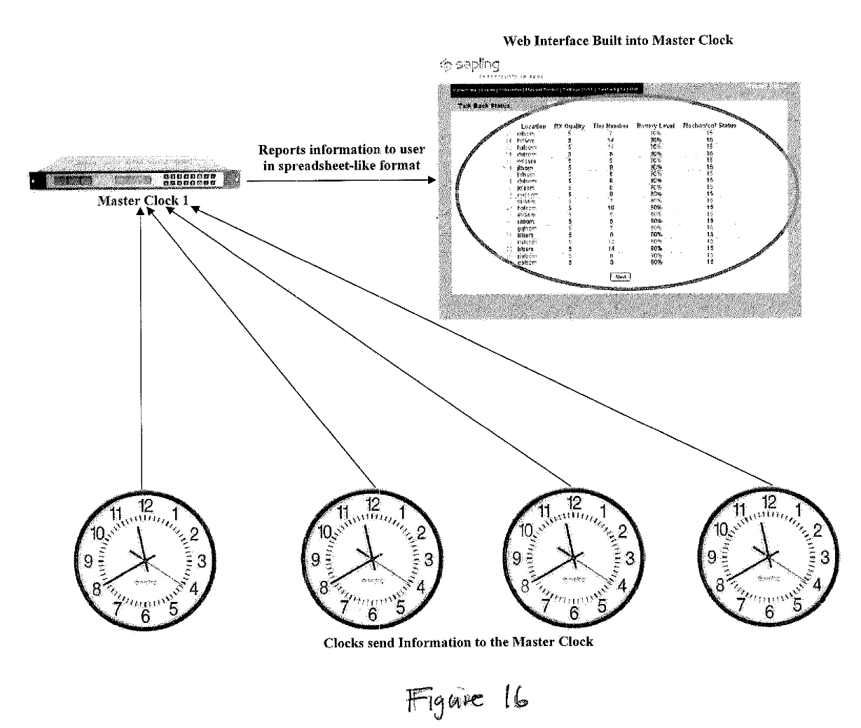

FIG. 16 shows a master clock with slave clocks, wherein the slave clocks transmit information to the master clock, such as, location, RX quality (the number of time signals that the slave clock receives compared to the number of time signals which were transmitted), tier number (the number of repeater slave clocks the time signal passes before being received by the slave clock), battery level, and mechanical status, and the master clock has an associated display which displays the information in spreadsheet format, with the user able to select a column for recording the data.

While the invention has been described herein with reference to certain preferred embodiments, these embodiments have been presented by way of example only, and not to limit the scope of the invention.

A preferred embodiment of the invention will be described, but the invention is not limited to this embodiment.

A normal operation of a basic wireless clock system will first be described. In a normal time packet, the master clock sends a start character, followed by the time/date, a packet CRC and a closing character to the slave clocks during normal operation. This is the only data the master clock sends when the wireless system is in normal operation. This is sent from the master clock and received and re-transmitted (repeated) to all the clocks of the mesh network. This is the end of the normal operation procedure.

In the system according to the invention, the communication between the master clock and slave clocks uses the same hardware and general data format as with the existing basic wireless system currently utilized in the aforementioned normal operation. However the present system has additional capability. When this additional capability is present, which may be implemented by software in the master clock and in the slave clocks, the master clock also sends out a separate data transmission/polling request to the slave clocks in the field asking the slave clocks for its current status.

When a slave clock is paired with the master clock, the slave clock is assigned a unique clock number and it is also assigned a master clock number. For example, clock #32 belongs to master clock #1. By assigning a slave clock a unique number and a specific master clock number, this allows the system to utilize more than one master clock without causing any ill effects to this system.

One of the pieces of data included in this transmission, from the master clock, is the specific slave clock addresses that are being polled for feedback in order to determine the operating condition of the slave clocks in the system. For example, the battery voltage is read by the individual slave clock and then transmitted within the data packet, along with other statistical data about the slave clock, back to the master clock in which it is paired, in response to the polling request.

These polling requests utilize the same frequency-hopping technology that is used in existing wireless clock systems described above in the normal operation. The master clock request, as well as subsequent responses from the slave clocks, passes through as many tiers of slave clocks as necessary for the message to get from the master clock to the destination slave clock, as well as the response from the slave clock back to the master clock.

In regards to the operation according to the present invention, the master clock starts the polling process by transmitting a start character which is followed by the master clock address (a.k.a. the master clock number), the slave clock address or range of addresses, command characters, a CRC packet and a closing character. Upon receipt of the master clock transmission, the slave clock must ask itself the following questions, and operates accordingly:
1. Do I belong to (am I paired with) this master clock number?
   (a) If yes, then the clock asks itself the next question.
   (b) If no, the clock turns its receiver off.
2. Am I the clock, or one of the clocks, that the master clock is searching for (polling)?
   (a) If yes, the slave clock will transmit its status back towards the master clock, possibly via other clocks, that relay the message. In addition, if the master clock is looking for a range of clocks, and not just one particular clock, the slave clock will also repeat the signal to the clocks in its radius.
   (b) If no, the clock repeats the transmission signal to the rest of the clocks in its radius.

All master clocks continue to listen for the data requested from the polled slave clock but only the correct master clock will respond to the data sent by the polled clock.

The present invention has the added ability to support a combination of wireless and Local Area Network (LAN) based systems, allowing real and virtual campuses to exist. This takes advantage of communications through the LAN and World-Wide-Web (WWW) if so configured. As with all devices on a LAN, the Network Repeaters have a unique LAN address. Each Network Repeater can process requests and transmit the status and the present invention clock data to and from a local or campus based clock system, greatly expanding the mesh network into a virtual mesh network. If a master clock is already located in a main building and the Network Repeater is installed in a satellite building, and the master clock sends out a system request, the Network Repeater will receive this via TCP/IP and send out the signal wirelessly to the slave clocks that are being requested from the master clock. When the slave clock(s) in the satellite building receive this request, they will authenticate if they are the clock that is being requested. If the clock is not the one requested, it will ignore the request and repeat it through the mesh network. If the clock is the one requested, it will send back its status back through the mesh network to the Network Repeater. The Network Repeater will then send that status update back to the main master clock via TCP/IP.

The communication between the master clock and slave clocks uses the same hardware and general data format as with the normal operation systems. In the present invention, additional data is transferred to the slave clocks via the master clock. This data incorporates the specific slave clock addresses that are being polled for feedback in order to determine the operating condition of the slave clocks in the system. For example, the battery voltage is read by the individual slave clock and this data is transferred with other data about the clock within this system's data packet sent by the slave clock in response to the poll from the master clock. It should be clear that the master cluck request, as well as subsequent responses, pass through as many tiers of slave clocks as is necessary for the message to get from the master clock to the destination slave clock as well as the response from the slave clock back to the master clock. The same advantage of the mesh network for transmitting the signal is used in reverse to receive the response.

For normal operation, a start character is followed by the time and date and a closing character. This is sent from the master clock and received and re-transmitted (repeated) to all the clocks of the mesh network. The master clock had done its job when it sent the time packet.

In regards to this system's operations, a start character is followed by the master clock address, the slave clock address, command characters, and a closing character. This is sent from the master clock and received and re-transmitted (repeated) to all the clocks of the mesh network until the clock(s) of interest receive its intended packet(s). This slave clock then responds by sending the requested data back to the addressed master clock. All master clocks continue to listen for the data requested from the polled slave clock but only the correct master clock will respond to the data sent by the polled clock.

While the invention has been described herein with reference to one preferred embodiment, this embodiment has been presented by way of example only, and not to limit the scope of the invention. The scope is defined only by the claims which follow.

What is claimed is:

1. A wireless system comprising:
a plurality of master time sources, each master time source wireless transmitting time signals containing time data;
a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks which receives and retransmits the time signals in repeater fashion; and
wherein each of the slave clocks is associated and paired with the master time source from which the time signal is first transmitted.

2. A wireless clock system, comprising:
a master time source for wirelessly transmitting time signals containing time data;
a plurality of slave clocks for wirelessly receiving time signals which cause the slave clocks to operate in synchronization with a source of the received time signals,
wherein the master time source has an internet connection for connection to a master computer for data exchange of operational performance data of the slave clocks.

3. The system according to claim 2, wherein a plurality of the slave clocks uses a battery power source.

4. The system according to claim 3, wherein the master time source has a display for displaying the battery level value of each slave clock having a battery power source.

5. The system according to claim 4, wherein the display can order the battery level values in a selected order, including at least one of the increasing values or decreasing values.

6. A wireless clock system, comprising:
a master time source for wirelessly transmitting time signals containing time data at intervals;
a plurality of slave clocks, each of the slave clocks receiving time signals which cause the slave clocks to operate in synchronization with a source of the received time signals,
each of said slave clocks transmitting back to said master time source data indicating the number of intervals in which in the slave clock has received a time signal.

7. The system according to claim 6, wherein the time signals are transmitted at periodic intervals.

8. A wireless clock system, comprising:
at least one master time source for wirelessly transmitting time signals containing time data;
a plurality of slave clocks for wirelessly receiving time signals which cause the slave clocks to operate in synchronization with a source of the received time signals;
wherein the master time source transmits the time signals periodically to effect time synchronization, and wherein each slave clock detects the number of time periods it receives the current time signals and for transmitting back to the number of times it receives the current time signals; and
wherein the master time source compares information representing when each slave clock receives the time signals during normal operation with when the slave clocks actually receive the current time signals to determine whether the slave clock is operating normally.

9. The system of claim 8, wherein the master clock has an associated display for displaying information representing when each clock receives the current time signals.

10. A wireless clock system, comprising:
at least one master time source for wirelessly transmitting time signals containing time data;
a plurality of slave clocks for wirelessly receiving time signals which cause the slave clocks to operate in synchronization with a source of the received time signals;
wherein performance data of each slave clock is transmitted back to the master time source for display and monitoring.

11. The system according to claim 10, wherein the master time source has an associated display for displaying the performance data of all of the slave clocks in spreadsheet fashion.

12. The system according to claim 10, wherein the performance data includes at least one of signal strength, battery level, software version, hardware version, and mechanical operation of the slave clock display.

13. The system according to claim 10, wherein the performance data includes all of signal strength, battery level, software version, hardware version, and mechanical operation of the slave clock display.

14. A wireless system comprising:
a plurality of master time sources, each master time source wireless transmitting time signals containing time data;
a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks; and
wherein each of the slave clocks determines the number of repeater slave clocks the time signal passes before being received by the slave clock as a tier value.

15. The system according to claim 14, wherein the slave clocks transmit data representing the tier value back to the master time source.

16. A method of operating a wireless system comprising:
providing a plurality of master time sources, each master time source wireless transmitting time signals containing time data;
providing a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks which receives and retransmits the time signals in repeater fashion; and
associating and pairing each slave clock with the master time source from which the time signal is first transmitted.

17. A method of operating a wireless clock system, comprising:
providing a master time source for wirelessly transmitting time signals containing time data;
providing a plurality of slave clocks for wirelessly receiving time signals which cause the slave clocks to operate in synchronization with a source of the received time signals; and
connecting the master time source to a master computer for data exchange of operational performance data of the slave clocks.

18. A method of operating a wireless clock system comprising:
providing a master time source for wirelessly transmitting time signals containing time data;
providing a plurality of slave clocks, each of the slave clocks receiving time signals which cause the slave clocks to operate in synchronization with a source of the received time signals,
operating at least one of the slave clocks operates using a battery power source, and transmitting a signal representing the battery level value of the slave clock from the slave clock to the master time source for monitoring.

19. The method according to claim 18, wherein a plurality of the slave clocks uses a battery power source.

20. The method according to claim 18, including displaying the battery level value of each slave clock having a battery power source.

21. The method according to claim 20, including arranging the battery level values in a selected order, including at least one of the increasing values or decreasing values.

22. A method of operating a wireless clock system, comprising:
providing a master time source for wirelessly transmitting time signals containing time data at intervals;
providing a plurality of slave clocks, each of the slave clocks receiving time signals which cause the slave clocks to operate in synchronization with a source of the received time signals, and
transmitting from each of said slave clocks back to said master time source data indicating the number of intervals in which the slave clock has received a time signal.

23. The method according to claim 22, comprising transmitting the time signals at periodic intervals.

24. A method of operating a wireless clock system, comprising:
providing at least one master time source for wirelessly transmitting time signals containing time data in a periodic manner;
providing a plurality of slave clocks for wirelessly receiving time signals which cause the slave clocks to operate in synchronization with a source of the received time signals;
detecting the number of time periods each slave clock receives the current time signals and transmitting back to the master time source the number of times it receives the current time signals; and
comparing information representing when each slave clock receives the time signals during normal operation with when the slave clocks actually receive the current time signals to determine whether the slave clock is operating normally.

25. The method of claim 24, comprising displaying information at the master time source representing when each clock receives the current time signals.

26. A method of operating a wireless clock system, comprising:
providing at least one master time source for wirelessly transmitting time signals containing time data;
providing a plurality of slave clocks for wirelessly receiving time signals which cause the slave clocks to operate in synchronization with a source of the received time signals; and
transmitting performance data of each slave clock is back to the master time source for display and monitoring.

27. The method according to claim 26, comprising displaying the performance data of all the slave clocks in spreadsheet fashion.

28. The method according to claim 27, wherein the performance data includes at least one of signal strength, battery level, software version, hardware version, and mechanical operation of the slave clock display.

29. The method according to claim 28, wherein the performance data includes all of signal strength, battery level, software version, hardware version, and mechanical operation of the slave clock display.

30. A method of operating a wireless system comprising:
providing a plurality of master time sources, each master time source wireless transmitting time signals containing time data;
providing a plurality of slave clocks, each of the slave clocks for wirelessly receiving time signals which cause the slave clocks to operate in synchronization with a source of the received time signals, the source of the received time signals for at least one of the slave clocks being the master time source and the source for each other one of the slave clocks being one of the master time source or another one of the slave clocks; and
determining the number of repeater slave clocks the time signal passes before being received by the slave clock as a tier value.

31. The method according to claim 30, wherein the slave clocks transmit data representing the tier value back to the master time source.

32. A wireless clock system, comprising:
at least two master clocks, each having a unique master clock number;
a plurality of slave clocks, each slave clock having a unique slave clock number, and being paired with a single master clock;
each master clock having a transmitter for transmitting a polling signal representing the identity of the master clock, the identity of at least slave clock to be polled, and a polling request for status of the at least one slave clock;
a receiver and processor within each slave clock for:
receiving polling signals;
determining whether the slave clock is paired with the master clock which sent the polling signal, and if not, turning off its receiver;
determining whether the polling request applies to that slave clock by comparing the identity of the at least one unique slave clock in the polling signal with its unique slave clock number;
transmitting status information if the polling request applies to the slave clock; and
determining whether the polling request applies to the other slave clocks and if so, retransmitting the polling signal;
and wherein only the master clock which transmits the polling signal will respond to status information transmitted by its paired slave clocks.

33. The wireless clock system of claim 32, wherein each master clock retransmits polling signals from other master clocks.

34. The wireless clock system of claim 32, wherein the polling signal includes at least one of a request for wireless signal quality, battery life, mechanical status, software version, hardware version, and wireless tier number.

35. The wireless clock system of claim 32, wherein the polling signal is transmitted in a frequency hopping matter.

36. The wireless clock system of claim 32, wherein each slave clock retransmits status information transmitted by other slave clocks.

37. The wireless clock system of claim 32, wherein the polling signal includes a start character, a master clock address which uniquely identifies the master clock, the slave clock address(es) for the slave clock(s) to be polled, command characters, a CRC packet and a closing character.

38. A method of operating a wireless clock system, comprising:
providing at least two master clocks, each having a unique master clock number;
providing a plurality of slave clocks, each slave clock having a unique slave clock number, and being paired with a single master clock;
transmitting from a master clock a polling signal representing the identity of the master clock, the identity of at least slave clock to be polled, and a polling request for status of the at least one slave clock;
each slave clock:
receiving polling signals;
determining whether the slave clock is paired with the master clock which sent the polling signal, and if not, turning off its receiver;
determining whether the polling request applies to that slave clock by comparing the identity of the at least one unique slave clock in the polling signal with its unique slave clock number;
transmitting status information if the polling request applies to the slave clock; and
determining whether the polling request applies to the other slave clocks and if so, retransmitting the polling signal;
and wherein only the master clock which transmits the polling signal will respond to status information transmitted by its paired slave clocks.

39. The method of claim 38, wherein each master clock retransmits polling signals from other master clocks.

40. The method of claim 38, wherein the polling signal includes at least one of a request for wireless signal quality, battery life, mechanical status, software version, hardware version, and wireless tier number.

41. The method of claim 38, wherein the polling signal is transmitted in a frequency hopping matter.

42. The method of claim 38, wherein each slave clock retransmits status information transmitted by other slave clocks.

43. The method of claim 38, wherein the polling signal includes a start character, a master clock address which uniquely identifies the master clock, the slave clock address(es) for the slave clock(s) to be polled, command characters, a CRC packet and a closing character.
